(19) United States
(12) Patent Application Publication
(10) Pub. No.: US 2026/0231062 A1
(43) Pub. Date: Aug. 6, 2026

(54) METHODS, ARCHITECTURES, APPARATUSES AND SYSTEMS FOR SYNCHRONIZATION SIGNALS

(71) Applicant: InterDigital Patent Holdings, Inc., Wilmington, DE (US)

(72) Inventors: Moon IL Lee, Melville, NY (US); Paul Marinier, Brossard (CA); Ghyslain Pelletier, Montreal (CA); Tao Deng, New York, NY (US)

(21) Appl. No.: 19/044,467

(22) Filed: Feb. 3, 2025

(51) Int. Cl. H04W 56/00; H04W 8/22; H04W 76/10

(52) U.S. Cl. CPC H04W 56/0015; H04W 8/22; H04W 76/10

(57) ABSTRACT

Methods and systems are provided for synchronization signals for a wireless transmit/receive unit (WTRU). The WTRU receive, from a wireless network, a first subset of components associated with a Synchronization Signal Block (SSB). The WTRU further receive configuration information for receiving a second subset of components associated with the SSB based on the first subset of components. The WTRU further receive, from the wireless network, the second subset of components associated with the SSB based on the configuration information; and establish a connection with the wireless network based on the SSB.

### BACKGROUND

The present disclosure is generally directed to the fields of communications, software and encoding, including, for example, to methods, architectures, apparatuses, systems related to synchronization signals.

A single synchronization signal structure is used for Radio Access Technologies (RATs) for initial access irrespective of user equipment capabilities, use cases, and/or traffic types. This presents challenges for specific use cases in terms of latency, performance, and/or energy consumption.

### SUMMARY

The present disclosure relates to enhancements to Synchronization Signal Blocks (SSBs) for Radio Access Technologies (RATs) and improving wireless transmit/receive unit (WTRU) efficiency. In some embodiments, a common SSB structure may be employed, comprising a common portion (e.g., a primary synchronization signal (PSS), a secondary synchronization signal (SSS), a common physical broadcast channel (PBCH)) and RAT-specific portions (e.g., a dedicated PBCH). In some embodiments, multiple SSB types may be defined, selectable by the WTRU based on PSS/SSS characteristics. In some embodiments, a modular SSB design may be used such that a WTRU selectively scans SSB components based on device capabilities, optimizing power consumption and acquisition time.

In certain representative embodiments, methods and systems are provided for a synchronization signal for a wireless transmit/receive unit (WTRU). The methods and systems may include a WTRU receiving, from a wireless network, a first subset of components associated with a Synchronization Signal Block (SSB) and the WTRU determining configuration information for receiving a second subset of components associated with the SSB based on the first subset of components. The methods and systems may further include the WTRU receiving, from the wireless network, the second subset of components associated with the SSB based on the configuration information and establishing a connection with the network based on the SSB.

In certain representative embodiments, methods and systems are provided for a synchronization signal for a wireless transmit/receive unit (WTRU). The methods and systems may include a WTRU performing a synchronization raster to detect a Synchronization Signal Block (SSB) associated with a wireless network, wherein a frequency location associated with the synchronization raster indicates a format type of Primary Synchronization Signal (PSS), Secondary Synchronization Signal (SSS) and Physical Broadcast Channel (PBCH) of the SSB. The methods and systems may further include the WTRU receiving, from the wireless network, the PSS, the SSS and the PBCH of the SSB. The methods and systems may further include the WTRU establishing a connection to the wireless network based on the SSB.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an exemplary NR SSB structure according to one or more embodiments;

FIG. 3 illustrates an exemplary SSB structure according to one or more embodiments;

FIG. 4 illustrates one or more SSB types according to one or more embodiments;

FIG. 5 illustrates a scalable SSB structure according to one or more embodiments;

FIG. 6 illustrates association between SSB type and Sync raster number according to one or more embodiments;

FIG. 7 illustrates a method for establishing a connection with a wireless network using an SSB according to one or more embodiments; and

FIG. 8 illustrates a method for establishing a connection with a wireless network using an SSB according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

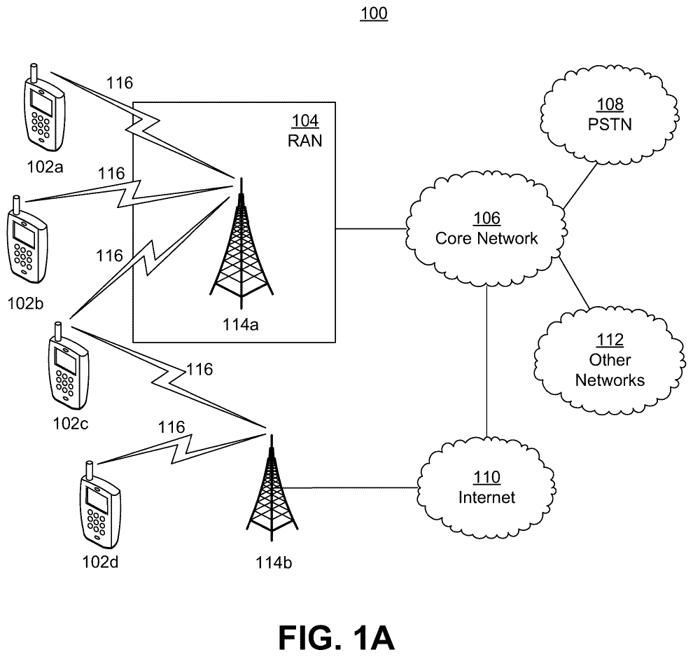

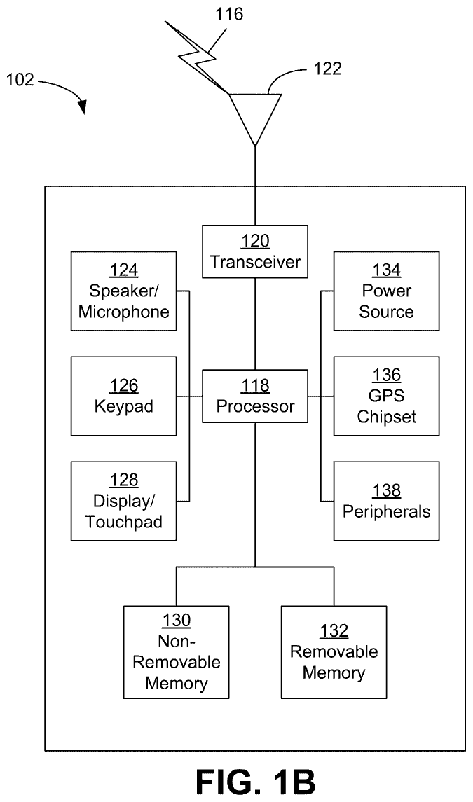

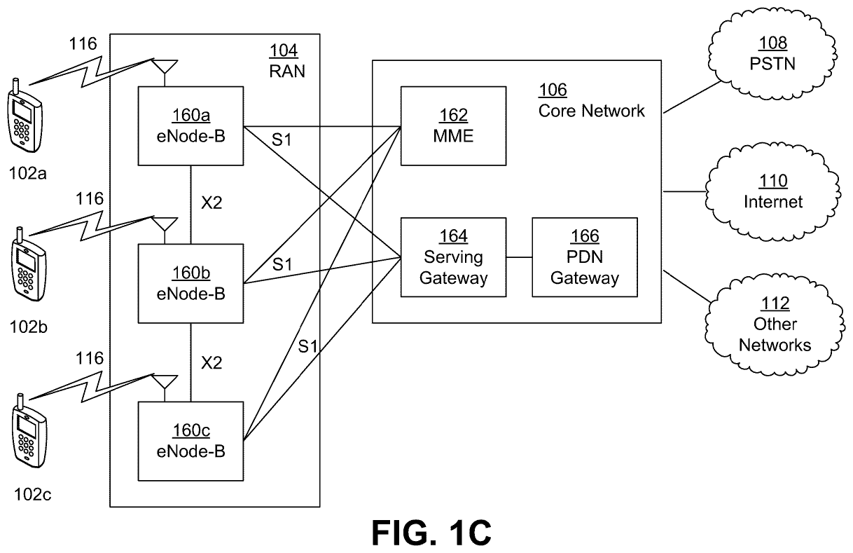

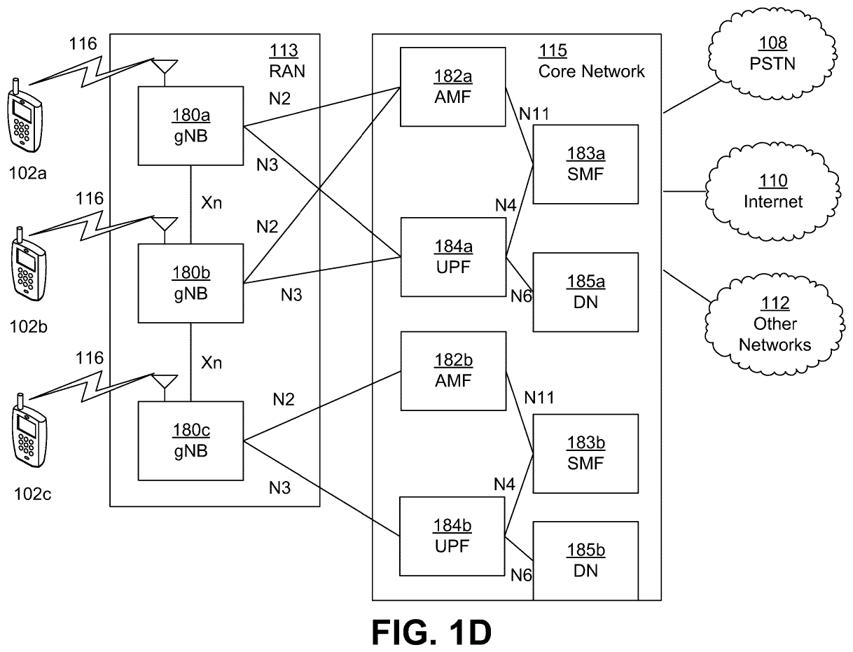

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In certain representative embodiments, a 5G New Radio (NR) may be provided. In 5G NR, a single Synchronization Signal Block (SSB) type may be defined and used. The SSB may include a primary synchronization signal (PSS), a secondary synchronization signal (SSS), and a physical broadcasting signal (Physical Broadcast Channel (PBCH)).

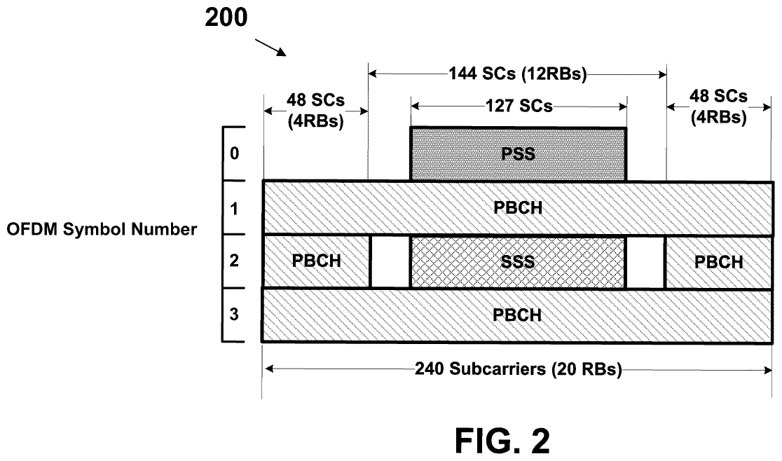

FIG. 2 illustrates an exemplary 5G NR SSB structure 200 according to one or more embodiments. The SSB 200 may comprise 240 subcarriers (which may be equivalent to 20 resource blocks (RBs)), wherein 1 RB consists of 12 subcarriers. The SSB may comprise synchronization signals (PSS and SSS). Hereafter, resource block (RB) may be interchangeably used with physical resource block (PRB). Synchronization signals (PSS, SSS) may be located within 12 PRBs including guard subcarriers. PBCH may be transmitted over 20 PRBs and located at all Orthogonal Frequency Division Multiplexing (OFDM) symbols except for the first OFDM symbol. Hereafter, synchronization signal may be interchangeably used with Sync signal, Sync channel, or Sync.

A WTRU may scan sync rasters to detect SSB in a certain frequency band or channel bandwidth, wherein the sync raster may be located in the middle of sync signal (e.g., middle subcarrier of sync signal if the sync signal has odd number of subcarriers) or subcarrier next to the middle of the sync signal (e.g., when the sync signal has even number of subcarriers). The reference frequency locations for Sync rasters may be predefined per frequency range (e.g., FR1, FR2), frequency band (e.g., frequency band number), and/or channel bandwidth (e.g., carrier bandwidth within a frequency band) which may be a carrier bandwidth used by a network.

In certain representative embodiments, in a Radio Access Technology (RAT) (e.g., LTE, 5G NR), a single synchronization signal structure may be designed and used for initial access irrespective of a WTRU capabilities, use cases, and/or traffic types. In certain representative embodiments, one or more SSB types are provided to enhance performance in terms of latency, performance, and/or energy consumption for a specific use case. In certain representative embodiments, one or more SSB types may be provided to enhance the minimum supported frequency bandwidth by a WTRU.

In certain representative embodiments, one or more SSB types may be used, wherein a WTRU may determine an SSB type for PBCH demodulation based on one or more detected properties of the associated PSS and SSS. Properties of the associated PSS and SSS may include one or more of physical cell-ID, sequency type of SSS, sequence number of SSS, time and/or frequency gap between PSS and SSS, and associated Sync raster number.

In certain representative embodiments, a WTUR may perform one or more of: the WTRU may turn on a device; the WTRU may scan SSB over Sync rasters until it receives valid PSS and SSS of an SSB; the WTRU may determine SSB type based on the detected PSS and SSS, a first SSB type may be determined if the detected physical cell-ID (PCID) belongs to a first Physical Cell Identifier (PCID) group associated with the first SSB type, a second SSB type may be determined if the detected PCID belongs to a second PCID group associated with second SSB type; or the WTRU may determine PBCH demodulation information (e.g., time/frequency resource allocation, Demodulation Reference Signal (DM-RS) configuration, payload size, Master Information Block (MIB) contents) based on the determined SSB type.

In certain representative embodiments, a SSB structure and MIB information may be optimized per use case, WTRU type, and Network (NW)-sided condition.

In certain representative embodiments, a single SSB structure may be used by different types of WTRUs and/or capabilities.

In certain representative embodiments, NW may optimize its performance (e.g., energy saving performance) by selecting SSB type based on the number of active WTRUs and/or WTRU types active in the cell.

In certain representative embodiments, a common SSB for multiple RATs may be provided. A WTRU may receive a first subset of SSB components (e.g., PSS, SSS, and common PBCH) in an SSB; and the WTRU may receive information related to presence/configuration of a second subset of SSB components (e.g., dedicated PBCH) from the first subset of SSB components. The WTRU may receive dedicated PBCH to receive broadcasting information for the target RAT.

In certain representative embodiments, multiple SSB types may be provided. One or more SSB types may be used, wherein a WTRU may determine an SSB type for PBCH demodulation based on one or more detected properties of the associated PSS and SSS. Properties of the associated PSS and SSS may include one or more of physical cell-ID, sequency type of SSS, sequence number of SSS, time and/or frequency gap between PSS and SSS, and associated Sync raster number.

In certain representative embodiments, modular SSB design may be provided. An SSB may consist of one or more SSB components, wherein SSB components may include one or more Sync parts and PBCH parts. A WTRU may determine a subset of SSB components to scan based on WTRU-sided conditions (e.g., WTRU capability, WTRU type, WTRU category). The subset of SSB components may be associated with one or more Sync raster numbers (e.g., GSCN number).

In certain representative embodiments, a Synchronization Signal Block (SSB) may be defined and/or used. Herein, SSB may be referred to as a set of signals/channels (or component signals/channels) which may provide one or more of timing and frequency synchronization; physical cell identity; minimum set of broadcasting information for initial access (e.g., MIB); boundary of symbol (OFDM symbol), slot, subframe, and/or frame; numerology (e.g., subcarrier spacing, Cyclic Prefix (CP) length); and availability of the cell (e.g., whether the WTRU can camp on the cell or not); status of the network or cell (e.g., network energy saving mode or not); network type (e.g., Terrestrial Network (TN) or Non-Terrestrial Network (NTN)), and so on.

The SSB may be interchangeably used with SS/PBCH block, SS channel, Sync signal, Sync channel, Initial Access Resource (IAR), Initial Access Channel (IAC), Cell Search Signal (CSS), Cell Search Channel (CSC), and Common Sync Signal (CSS).

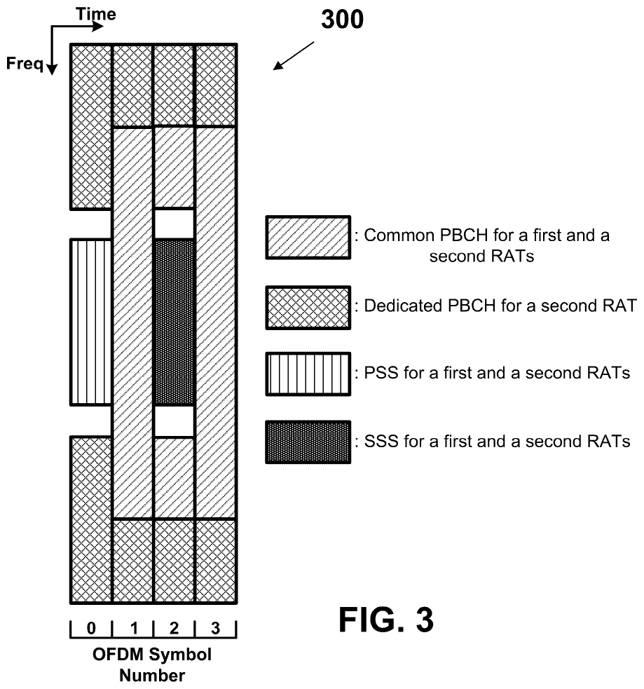

FIG. 3 illustrates an exemplary SSB structure 300 according to one or more embodiments. The SSB structure 300 may be a Common SSB (C-SSB) which may be shared by multiple RATs (e.g., 5G and 6G) in one or more frequency spectrums.

In certain representative embodiments, an SSB may be used, defined, or shared by one or more RATs (e.g., 5G and 6G). When an SSB is shared across one or more RATs, it may be referred to as a common SSB (C-SSB). Hereafter, C-SSB may be interchangeably used with SSB, shared SSB (S-SSB), unified SSB, and multi-RAT SSB.

In certain representative embodiments, a C-SSB may be used for a specific RAT (e.g., 5G or 6G) and when a WTRU detected or received a C-SSB, the WTRU may determine the associated RAT for the detected C-SSB based on one or more of the associated Sync raster location, the characteristic of the Sync signal received in the C-SSB, the physical cell-ID detected, the target Public Land Mobile Network (PLMN) identity.

The associated Sync raster location (e.g., reference frequency location) of the C-SSB detected may be used. In some embodiments, when a C-SSB is detected with a Sync raster which may belong to a Sync raster set associated with a first RAT (e.g., 5G RAT), the WTRU may determine the C-SSB as the first RAT SSB; when the C-SSB is detected with a Sync raster which may belong to a Sync raster set associated with a second RAT (e.g., 6G RAT), the WTRU may determine the C-SSB as the second RAT SSB. The Sync rasters in the first Sync raster set and those in the second Sync raster set may be mutually exclusive (e.g., not overlap in frequency). Alternatively, the Sync rasters in the second Sync raster set may be a subset of the sync rasters in the first Sync raster set. When the second Sync raster set is a subset of the first Sync raster set, a WTRU may scan C-SSB on the Sync rasters in the second Sync raster set while the WTRU may scan the first RAT specific SSB (e.g., 5G-NR SSB) on the Sync rasters not belonging to the second Sync raster set. The second Sync raster set may be every n-th Sync rasters in the first Sync raster set starting from the first Sync raster in the first Sync raster set, wherein the ‘n’ may be pre-defined, or determined based on one or more of following: network operator identity (e.g., PLMN-id), geographical region of WTRU and/or target network, frequency band number (n31, n32, etc.), channel bandwidth, frequency range (e.g., FR1, FR2, FR3). The Sync rasters in the second Sync raster set may be prioritized or deprioritized for scanning SSB. The prioritization may be predetermined or determined based on one or more of following: network operator identity (e.g., PLMN-id), geographical region of WTRU and/or target network, frequency band number (n31, n32, etc.), channel bandwidth, frequency range (e.g., FR1, FR2, FR3).

Associated Physical cell-ID (PCID) may be determined based on the associated RAT. In some embodiments, a same sequence of PSS and/or SSS may be mapped to a different physical cell-ID based on the determined associated RAT. Therefore, a PCID may be determined based on Sync raster number and/or Sync raster set (e.g., Global Synchronization Channel Number (GSCN)); and/or sequence index detected from one or more of Sync signal (e.g., PSS and/or SSS).

The characteristic of the Sync signal received in the C-SSB, wherein the Sync signal characteristics may include one or more of the following properties: sequence number, sequence index, sequence initialization index, sequence length, and/or sequence type (e.g., m-sequence, Zadoff-Chu sequence, gold-sequence, etc.).

The physical cell-ID detected may be used, wherein the physical cell-ID may be determined based on the sequence detected from PSS, SSS, or combination of both. The target PLMN identity may be used. In some embodiments, when a WTRU scans C-SSB, the WTRU may determine which PLMN identity is targeted and based on the target PLMN identity, the WTRU may determine the associated RAT for the C-SSB.

In certain representative embodiments, broadcasting information carried in the C-SSB (e.g., MIB) may have one or more bit-fields which may be commonly used for multiple RATs. The bit fields commonly used across multiple RATs may be referred to as common broadcasting information (CBI) and one or more bit-fields which may be dedicated to a specific RAT may be referred to as dedicated broadcasting information (DBI). CBI may include system related information which may be commonly used across multiple RATs (e.g., system frame number, subcarrier spacing, CP length, waveform, etc.). CBI may be carried in common PBCH (e.g., in FIG. 3). DBI may include RAT-specific broadcasting information such as but not limited to PDCCH common search space configuration, cell-barring, SSB sub-carrier and/or RB offset (e.g. to indicate RAT Common Resource Block (CRB) information), etc. DBI may be carried in dedicated PBCH (e.g., in FIG. 3).

In certain representative embodiments, a WTRU targeting or attempting to detect a first RAT (e.g., 5G RAT) may receive or scan a C-SSB as the same as the SSB of the first RAT (e.g., 5G RAT, dedicated SSB for 5G RAT), wherein a subset of C-SSB component signals and/or channels may have the same structure as the first RAT (e.g., SSB in the FIG. 2), wherein C-SSB component signals and/or channels may be PSS, SSS, common PBCH, and dedicated PBCH as shown in the FIG. 3. A WTRU targeting or attempting to detect a second RAT (e.g., 6G RAT) may receive information related to the second RAT in one or more of the bit fields in the MIB which may be carried in PBCH (e.g., common PBCH). The information related to the second RAT may be time and/or frequency resource information for dedicated SSB for the second RAT. In this case, after a WTRU detected a C-SSB, the WTRU may need to detect additional dedicated SSB for the second RAT to access the second RAT. The information related to the second RAT may be one or more of the following: presence of the dedicated SSB, time/frequency location information for the dedicated SSB (e.g., offset from C-SSB), PCID of the second RAT (e.g., an offset value from the PCID detected from the C-SSB), a configuration of PDCCH common search space, DM-RS configuration for dedicated PBCH, PDCCH, and/or PDSCH, periodicity of the dedicated SSB, sub-carrier-spacing (SCS) of the dedicated SSB, the transmit power of the dedicated SSB, the SSB index of the dedicated SSB.

The dedicated SSB may be located in a non-overlapped time/frequency location with the common SSB, the dedicated SSB may be based on PDCCH and PDSCH transmission. In this case, no dedicated Sync signal may be used for the SSB and PDSCH may carry broadcasting information for the second RAT. Hereafter, broadcasting information may be interchangeably used with system information (SI), system information block (SIB), master information (MI), and master information block (MIB).

A C-SSB may consist of one or more component signals and/or channels and a subset of component signals and/or channels may be used as a dedicated SSB for a RAT. In some embodiment, for example in FIG. 3, PSS, SSS, common PBCH, and dedicated PBCH may be referred to as component signals and channels; and the first subset of component channels and/or signals may be PSS, SSS, and common PBCH and the second subset of component channels and/or signals may be PSS, SSS, common PBCH, and dedicated PBCH, wherein the first subset may be used the dedicated SSB for a first RAT (e.g., 5G RAT) and the second subset may be used for the dedicated SSB for a second RAT (e.g., 6G RAT). The common PBCH may carry information (e.g., using a reserved bit in the MIB or re-interpret of some of existing bit field) related to whether the component signal and/or channel belongs to the second subset is present or not. If the component signal and/or channel belongs to the second subset is not present, a WTRU targeting for the second RAT may assume or consider that the second RAT is not supported or present in this cell. The common PBCH may be referred to as a first part PBCH (e.g., PBCH part 1) and the dedicated PBCH may be referred to as a second part PBCH (e.g., PBCH part 2). A WTRU targeting to camp on a first RAT may need to receive only PBCH part 1 to receive subsequent broadcasting signals/channels while a WTRU targeting a second RAT may need to receive both PBCH part 1 and PBCH part 2 to receive subsequent broadcasting signals/channels.

In certain representative embodiments, DM-RS structure, pattern, sequence initialization index, scrambling sequence index and/or density may be determined based on the associated PBCH type (e.g., common PBCH or dedicated PBCH) within a C-SSB.

PSS/SSS and/or common PBCH of the common SSB may provide demodulation information for the dedicated PBCH including but not limited to presence of dedicated PBCH, DM-RS configuration information for dedicated PBCH, and time/frequency location information of dedicated PBCH, wherein the time/frequency location information may be based on one or more offsets from the common SSB (e.g., PSS, SSB or reference subcarrier of the first symbol of the common SSB). A WTRU may determine demodulation information of the dedicated PBCH (e.g., DMRS structure, pattern, density, and/or sequence) based on the information received from the common PBCH and/or information indicated in the synchronization signal(s) in the common SSB. In one example, a WTRU may determine a DM-RS sequence index and/or the scrambling sequence index using the PCI of the second RAT (on the PCI of the first RAT) and/or the SSB index indicated by the common SSB. A WTRU may receive presence of dedicated PBCH from the common PBCH. If the common PBCH indicates that there is no dedicated PBCH, the WTRU may determine that there is no second RAT supported in the cell.

Hereafter, SSB component, SSB component channel, SSB component signal, component, component channel, and component signal may be interchangeably used. SSB component may include one or more of but not limited to Sync signal, PSS, SSS, PBCH, common PBCH, dedicated PBCH, additional PBCH, PBCH part1, and PBCH part2.

In certain representative embodiments, one or more SSB types may be used, defined, or configured. An SSB type may be determined based on one or more of a set of SSB components, an occupied frequency bandwidth of the SSB, a frequency range, an occupied number of symbols (e.g., OFDM symbols, DFT-s-OFDM symbols) for the SSB, an order of SSB components in time, time/frequency location of SSB components, broadcasting information provided.

A set of SSB components may be used, wherein the SSB component may include one or more of Sync signal, PSS, SSS, PBCH, common PBCH, dedicated PBCH, additional PBCH, PBCH part1, and PBCH part2. In some embodiments, a first SSB type may include or consist of PSS, SSS, and PBCH; a second SSB type may include or consist of PSS, SSS, PBCH, and additional PBCH (A-PBCH); a third SSB type may include or consist of PSS and SSS; a fourth SSB type may include or consist of PSS only.

An occupied frequency bandwidth of the SSB may be used. In some embodiments, a first SSB type may be defined or determined with a first frequency bandwidth (e.g., 1.4 MHz) and a second SSB may be defined or determined with a second frequency bandwidth (e.g., 2.8 MHz). Alternatively, number of subcarriers required for the SSB may determine SSB type.

A frequency range may be used. In some embodiments, a first SSB type may defined or determined to be located according to the associated sync raster configuration in a frequency range corresponding to the full bandwidth of carrier. And a second SSB type may be defined or determined in to be located according to the associated sync raster configuration in a frequency range corresponding to (pre)configured part of the carrier bandwidth, e.g. in the lower, center or upper part of the carrier.

An order of SSB components in time may be used. In some embodiments, a first SSB type may be in the order of PSS, PBCH, SSS, and PBCH in time; and a second SSB type may be in the order of SSS, PBCH, PSS, and PBCH in time.

Time/frequency location of SSB components may include one or more of: time gap between PSS and SSS or frequency gap between PSS and SSS.

Broadcasting Information may be provided. In some embodiments, a first SSB type may provide broadcasting information (e.g., MIB) required for initial access and a second SSB type may provide broadcasting information to switch from a first WTRU status (e.g., RRC idle/inactive, energy saving mode) to a second WTRU status (connected, normal energy mode).

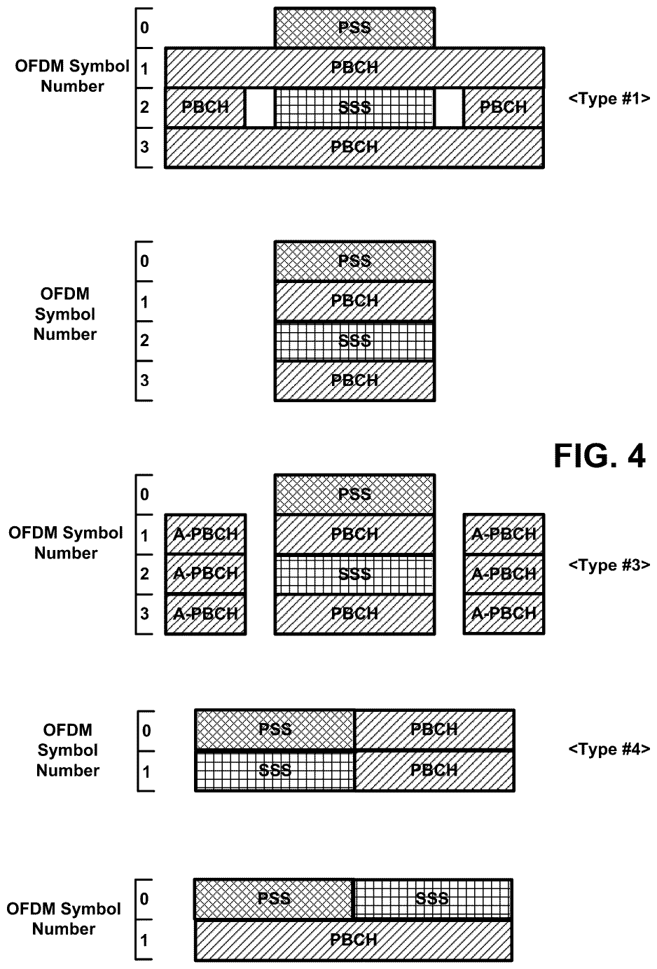

FIG. 4 illustrates one or more SSB types according to one or more embodiments.

With reference to FIG. 4, type #1 SSB may be an SSB used by a first RAT (e.g., existing RAT, 4G RAT, 5G RAT). This SSB type may be used for supporting WTRUS for the first RAT.

Type #2 SSB may have an SSB structure with the same number subcarriers for all SSB components (e.g., PSS, SSS, and PBCH). This SSB type may be used for a WTRU with limited frequency bandwidth (e.g., low capability WTRU, IoT devices, etc.).

Type #3 SSB may have an SSB structure where additional PBCH (A-PBCH) located next to the second SSB type. This SSB type may be used for supporting different WTRU types (e.g., a first WTRU type which may receive only PSS, SSS, and PBCH; and a second WTRU type which may receive PSS, SSS, PBCH and A-PBCH, wherein A-PBCH may include information dedicated for the second WTRU type). The dedicated information for the second WTRU type may include one or more of the following: Broadcasting channel (e.g., SIB) configuration information for the second WTRU type (e.g., PDCCH common search space for the second WTRU type), Initial bandwidth part (BWP) configuration information for the second WTRU type.

Type #4 SSB may have an SSB structure with smaller number of OFDM symbols used (e.g., 2 symbols). This SSB type may be used for WTRU requiring low latency services.

Type #5 SSB may have an SSB structure where PSS and SSS located in the same OFDM symbol. This SSB type may be used for WTRU requiring low latency services.

In certain representative embodiments, SSB types may be categorized into one or more of followings: Long and wide-BW SSB (e.g., Type #1 and Type #3 in FIG. 4): LW-SSB type, Long and narrow-BW SSB (e.g., Type #2 in FIG. 4): LN-SSB type, Short and wide-BW SSB (e.g., Type #4 and Type #5 in FIG. 4): SW-SSB type, Short and narrow-BW SSB: SN-SSB type.

In certain representative embodiments, one or more SSB types may be used, wherein one or more SSB types may have same time/frequency location of PSS and SSS from an associated Sync raster while PBCH resources may be mapped differently based on SSB type. In some embodiments, Type #1, Type #2, and Type #3 in the FIG. 4 may have the same PSS and SSS location from an associated Sync raster while PBCH resources may be located differently based on the SSB type. One or more of following may apply: SSB type may be indicated or determined based on the properties of PSS and/or SSS, wherein the properties of the PSS and/or SSS may include one or more of the following: Sequency number of SSS (e.g., sequence index of the SSS); Combination of the sequence numbers from PSS and SSS (e.g., physical cell id), in this case, physical cell ID (PCID) may be associated with SSB type; Sync raster number (e.g., GSCN number) associated with the PSS and/or SSS; Power difference between PSS and SSS (e.g., power spectral density level difference between PSS and SSS); Frequency offset level difference between PSS and SSS, wherein frequency offset level may be in terms of number of subcarriers shifted between PSS and SSS; Sequence type detected for PSS and/or SSS; The frequency range within a carrier where PSS and/or SSS may be detected, a WTRU may determine SSB type for PBCH reception based on the properties of PSS and/or SSS detected.

In certain representative embodiments, a WTRU may detect or scan PSS and SSS irrespective of the SSB type at a Sync raster and the detected PSS and SSS may indicate the demodulation information of PBCH, wherein the demodulation information of PBCH may include one or more of the following: Time/frequency resource allocation of PBCH as a reference of the associated Sync raster, or as a reference of the associated PSS and SSS; DMRS configuration of the PBCH; Modulation order of the PBCH; Numerology related information (e.g., subcarrier spacing, CP length, etc.); Scrambling sequence related information (e.g., sequence initialization index, sequence type, etc.); Repetition factor; Transmission power level (e.g., as compared to PSS and/or SSS); Periodicity of PBCH.

In certain representative embodiments, an SSB type may be determined based on the use case or functionality of the SSB. The use case and/or functionality of the SSB may include one or more of the following: cell-defining vs. non-cell defining SSB, a coverage level, energy saving mode, frequency resources, target service operator, geographical region, WTRU capability, type, and/or category.

Cell-defining vs. non-cell defining SSB may be used, wherein cell-defining SSB may be an SSB used for initial access while non-cell defining SSB may be an SSB used for other purposes (e.g., time/frequency synchronization, detect a frequence resource (e.g., BWP) for a specific WTRU type, SSB measurement, etc.) after initial access procedures. The initial access procedure herein may be referred to as procedure including one or more of cell search, broadcasting signal reception, RACH procedure, and RRC connection setup complete); LW-SSB type may be used for cell defining SSB while SW-SSB type may be used for non cell defining SSB.

Coverage level may be used (e.g., coverage level #1, coverage level #2, coverage level #3, etc.). An SSB requiring a higher coverage level (e.g., coverage level #3) may use LW-SSB type while an SSB requiring a lower coverage level (e.g., coverage level #1) may use SW-SSB type or SN-SSB type. A coverage level may be referred to as a coverage level of the cell (e.g. target cell). In some embodiments, a lower coverage level may be required for a TN cell and a higher coverage level may be required for an NTN cell. Based on the target coverage level, a WTRU may determine SSB type. A coverage level may be referred to as a coverage level of a WTRU. After initial access, a WTRU may determine its coverage level based on a measurement from a reference signal from the cell or network. Based on the measurement, the WTRU may determine its coverage level. For the use case of non cell defining SSB, the WTRU may determine SSB type based on its coverage level.

Energy saving mode of the network may be used (e.g., network energy saving (NES) mode #1, NES mode #2, NES mode #3, etc.), wherein NES mode #1 may be referred to as normal mode, NES mode #2 may be referred to as medium energy saving mode, and NES mode #3 may be referred to as a high energy saving mode. LW-SSB type may be used for NES mode #1 while SW-SSB or SN-SSB may be used for higher NES mode (e.g., NES mode #2 or NES mode #3).

Frequency resources may be used (e.g., initial BWP, non-initial BWP), a first SSB type (e.g., LW-SSB) may be used for a frequency resource used for a default BWP and/or initial access and a second SSB type (e.g., SW-SSB or SN-SSB) may be used for a BWP configured after initial access. A first SSB type (e.g., LW-SSB) may be used for a frequency resource shared with a different RAT (e.g., a frequency band used for 5G and 6G); while a second SSB type (e.g., SW-SSB) may be used for a frequency resource dedicated for a RAT (e.g., 6G) An SSB type may be determined based on frequency band index. For example, one or more frequency band index may be defined, and each frequency band index may be associated with an SSB type (e.g., n1: LW-SSB, n2: SW-SSB, n3: SN-SSB, etc.).

Target service operator may be used (e.g., PLMN-id), an SSB type may be determined based on a target PLMN-id. For example, a first SSB type may be used for a first service operator (e.g., first PLMN-id) and a second SSB type may be used for a second service operator (e.g., second PLMN-id).

Geographical region may be used (e.g., country), an SSB type may be determined based on geographical location of a WTRU (or target TRP/Cell), wherein the geographical location may be determined based on zone-id where a WTRU located or a country where a WTRU located.

WTRU capability, type, and/or category, an SSB type may be determined based on a target WTRU type, capability, and/or category. In an example, which SSB type to scan may be determined based on the WTRU capability, type, and/or category. For example, a first WTRU type (e.g., eMBB services) may determine to scan a first SSB type (e.g., LW-SSB); a second WTRU type (e.g., IoT services) may determine to scan a second SSB type (e.g., LN-SSB); a third WTRU type (e.g., URLLC services) may determine to scan a third SSB type (e.g., SW-SSB); and so forth.

In certain representative embodiments, an SSB type may be determined based on one or more of WTRU-sided conditions, network-sided conditions, and frequency spectrum related conditions. The WTRU-sided condition, NW-sided condition, and frequency spectrum related condition may be referred to as described in the following paragraphs.

WTRU-sided condition may include one or more of the following and interchangeably used with WTRU capability, WTRU category, WTRU condition, and WTRU type: WTRU capabilities (e.g., number of Tx/Rx antennas, supporting frequency bandwidth for downlink and/or uplink, device type, WTRU categories, support of low power receiver, maximum transmission power, supporting feature group, supporting functionalities, etc.); WTRU device status (e.g., remaining battery level, device temperature, etc.); WTRU's geographical location related information (e.g., zone-ID, cell-ID, TRP-ID, anchor WTRU identity) which may be acquired by WTRU based on WTRU's positioning information and zone defined, or cell and/or TRP the WTRU currently camp on or previously camped on, an anchor WTRU with which a WTRU currently communicating or previously communicated; Target operator identity (e.g., PLMN-id); Target use case (e.g., eMBB, URLLC, IoT, IIoT, etc.); WTRU channel conditions (e.g., RSRP level, SINR level, frequency selectivity level, LoS probability, indoor/outdoor, cell center or cell edge, etc.); WTRU mobility conditions (e.g., WTRU speed, WTRU's moving direction, WTRU's handover frequency); WTRU network connection status (e.g., RRC connected, RRC idle, RRC inactive); Coverage level of the WTRU.

NW-sided condition may include one or more of the following and interchangeably used with NW-side configuration, NW-side information, NW condition, and NW type: Network operator related information (e.g., PLMN identity); Cell related information (e.g., physical cell identity, global cell identity, etc.); Cell barring related information (e.g., supported WTRU types, WTRU categories, WTRU types and/or categories and/or WTRU capabilities not allowed for camping on the cell); NW capability related information including but not limited to Support and/or activation of WTRU power saving mode (e.g., wake up signal, PDCCH skipping, UL skipping, etc.), Support of low-layer triggered mobility (LTM), Support of a specific service (e.g., broadcasting, positioning, sensing, AI/ML, etc.); RAT related information including but not limited to Support and/or deployment of generation (4G, 5G, 6G, etc.), Support of multi-RAT spectrum sharing (MRSS) with one or more generation (e.g., 4G, 5G, and 6G): Transmitter (e.g., gNB, TRP, satellite, anchor WTRU) geographical information (e.g., country, zone); NW type (e.g., terrestrial network or non-terrestrial network); NW radio capability (e.g., number of antennas, active number of antennas, transmission power, number of beams, beamwidth, beam footprint, latency); NW mode of operation (e.g., network energy saving mode, normal energy mode, etc.); NW energy saving status (e.g., on/off Cell-DTX/DRX, cell-DTX/DRX configuration, etc.); NW traffic load status (e.g., high, medium, low); Broadcasting channel transmission type (e.g., on-demand SSB, on-demand SIB1, on-demand SIBx, always on SSB, always on SIB1, etc.), when a WTRU identified broadcasting channel transmission type, if it is based on on-demand, the WTRU may request in the pre-configured, or configured uplink resource to request the signal or channel; RAN sharing status (e.g., whether RAN sharing across multiple operators are used or not).

Frequency spectrum related condition may include on or more of following: Operating frequency band which may indicate frequency bandwidth, frequency region, absolute frequency, etc. Herein Operating frequency band may be associated with an index (e.g., frequency band number such as n1, n2, . . . , n94) and represent frequency spectrum with a starting frequency and ending frequency, and duplex mode (TDD, FDD); Operating bandwidth (e.g., frequency resource used, configured, determined for a certain operation such as default bandwidth part (BWP) which may be used for initial access, default operation, fallback operation, BWP used for common channel transmission (e.g., SSB, paging, SIB, PDCCH common search space); Channel bandwidth (e.g., actual channel bandwidth used by the operator within the operating frequency band); Frequency range (e.g., FR1, FR2, FR3); Carrier bandwidth (e.g., target carrier bandwidth within a frequency band); Sync raster number or identity, wherein Sync raster number or identity may be determined based on the reference frequency of the Sync raster. In one example, the identity may be global synchronization channel number (GSCN).

In certain representative embodiments, a WTRU may be informed or indicated from detected SSB type. For example, a WTRU may scan one or more SSB types (e.g., blindly detect one or more SSB types) on a Sync raster. Based on the detected SSB type on the Sync raster, the WTRU may determine one or more of the following: RAT type (e.g., 5G or 6G). In an example, a first SSB type may be used for 5G RAT and a second SSB type may be used for 6G RAT; Usage of the spectrum (e.g., dedicated for a single RAT or spectrum sharing across multiple RATs). In an example, a first SSB type (e.g., LW-SSB) may be used for a single RAT and a second SSB type (e.g., SW-SSB) may be used for spectrum sharing across multiple RATs (e.g., spectrum sharing between 5G and 6G); Supporting of a specific WTRU type. In some embodiments, if a first type WTRU (e.g., IoT type of WTRU) detect a first type of SSB (e.g., SN-SSB), the WTRU may determine that the cell is supporting the first type of WTRU and the WTRU may attempt to receive subsequent broadcasting information. Otherwise, the WTRU may scan other Sync raster and/or target SSB type; System configuration related information (e.g., waveform, subcarrier spacing, SSB periodicity); Network type (e.g., TN or NTN); Network energy saving mode (e.g., NES mode #1, NES mode #2, NES mode #3, etc.) of the network; Frequency resource type (e.g., default BWP, initial BWP, etc.); Geographical region (e.g., zone-ID, a set of zone-ID, etc.); coverage level (e.g., cell coverage level).

In certain representative embodiments, a WTRU may blindly detect one or more SSB types in a Sync raster, wherein each Sync raster (or GSCN number) may be associated with a subset of SSB types. In some embodiments, a first subset of SSB types (e.g., Type #1 and Type #2 in FIG. 4) may be associated with a first Sync raster (or a first Sync raster set) and a second subset of SSB types (e.g., Type #3 and Type #4 in FIG. 4) may be associated with a second Sync raster (or a second Sync raster set). A WTRU may blindly detect the associated with SSB types on a Sync raster.

The association (e.g., association between Sync raster index and a subset of SSB types) may be predefined or preconfigured. Herein, Sync raster index may be referred to as an associated GSCN number or other terminologies which may represent an index or identifier associated with the reference frequency of a Sync raster.

The association may be determined based on one or more of the following: Network operator identity (e.g., PLMN-id); Geographical region where a WTRU and/or a target network located; Network types (e.g., TN or NTN); RAT type (e.g., 5G or 6G); Spectrum sharing type (e.g., dedicated to a specific RAT or shared with multiple RATs); and/or WTRU types.

The association related configuration may be provided from a primary cell, a master node, default cell, cell in coverage layer, NTN cell, TN cell, primary carrier, and/or any type of transmission point which may assist a WTRU to detect another transmission point.

The subset of SSB types may be a single SSB type. In this case, an SSB type may be determined based on a Sync raster (e.g., GSCN number or index).

In certain representative embodiments, a WTRU may scan, attempt to decode, or monitor a subset of SSB type based on the WTRU capability (e.g., maximum supporting frequency bandwidth). A WTRU supporting a first maximum frequency bandwidth (e.g., 1.4 MHz) scans a first SSB type (e.g., LN-SSB). In the case where SSB type has an association with a Sync raster (e.g., GSCN number or index), a WTRU may scan a subset of GSCNs associated with the target (or supported) SSB type.

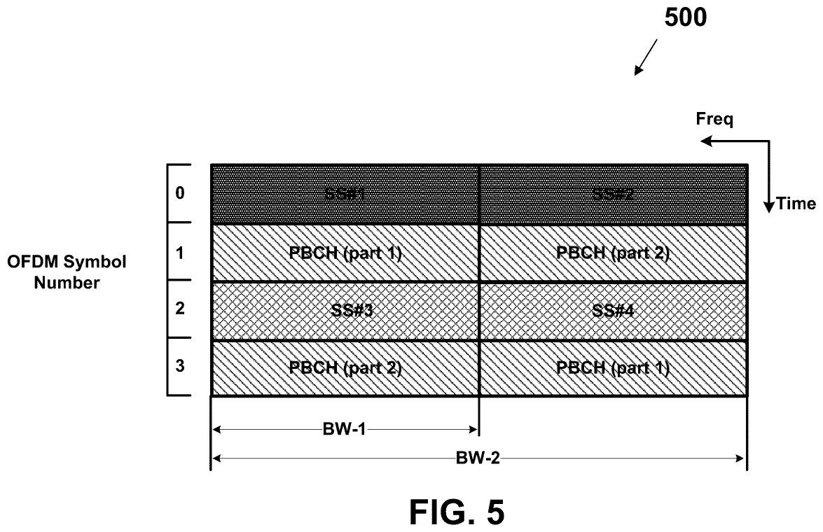

FIG. 5 illustrates a scalable SSB structure 500 according to one or more embodiments. In certain representative embodiments, an SSB may consist of one or more SSB components and a WTRU may use or determine a subset of SSB components based on one or more of WTRU sided conditions, network (NW) sided condition, and/or frequency spectrum related conditions. One or more of the conditions in the following paragraphs may apply.

The SSB components may include one or more of the following: one or more Sync parts (e.g., Sync signal, primary Sync signal, secondary Sync signal, first Sync signal, second Sync signal, etc.); one or more PBCH parts (e.g., PBCH part1, PBCH part2, etc.); demodulation reference signal (DM-RS) for broadcasting channel (e.g., PBCH); measurement reference signal (e.g., CSI-RS, PRS, TRS, etc.); physical broadcasting channel (PBCH); physical paging channel (PCH); Physical downlink control channel (PDCCH).

A WTRU may determine a subset of SSB components to scan in one or more Sync rasters based on one or more of WTRU-sided conditions, NW-sided conditions, and frequency spectrum related conditions. In some embodiments, a WTRU may determine a first subset of SSB components (e.g., SS #1, SS #2, PBCH part1 and PBCH part2 in FIG. 5) if the WTRU has a capability to receive larger than BW−2; a WTRU may determine a second subset of SSB components (e.g., SS #1, SS #3, PBCH part1 and PBCH part2 in FIG. 4) if the WTRU has limited capability to receive signal within BW−1.

One or more of the same SSB components may be used, transmitted, or located in an SSB. In some embodiments, two PSS and two SSS may be used in an SSB. The same SSB component may be repeated in an SSB, which may improve coverage of the SSB if a WTRU can receive repeated component signal or channel. A low capability WTRU may only receive a subset of component signals and/or channels in the SSB.

In some embodiments, more than one Sync signal may be transmitted in the same OFDM symbol, wherein Sync signals may be located consecutively in frequency domain without a frequency gap, or Sync signals may be located consecutively in frequency domain with a frequency gap. The frequency gap may be pre-configured or determined based on one or more of WTRU-sided condition, NW-sided condition, and/or frequency spectrum (FS) related condition. When the Sync signals transmitted in the same OFDM symbol as a part of an SSB may have one or more of following characteristics: the Sync signals are generated from the same sequence and split into multiple component sequences (e.g., parts), wherein each component sequence (e.g., part) may be a Sync signal. In some embodiments, a length N sequence may be generated and a part of the sequence (e.g., length M, M<N) may be used as a Sync signal. If a WTRU aggregates one or more Sync signals, the aggregated Sync signals in the same OFDM symbol may be the same as the length N sequence.

In some embodiments, for example in FIG. 3, the SS #1 and SS #2 may be generated from a same sequence and SS #1 may be a first part of the sequence and SS #2 may be second part of the sequence. The Sync signals may be generated independently. In some embodiments, one or more Sync signals are generated using the same sequence type (e.g., m-sequence, gold sequence, Zadoff-Chu sequence) but with different sequence initialization. Alternatively, Sync signals may be generated from different sequence type. The Sync signals may be the same sequence. E.g., a same Sync signal may be repeated in the same OFDM symbol to increase coverage. A WTRU with limited coverage may aggregate one or more Sync signals to overcome coverage while a WTRU with a good geometry may use a subset of Sync signals.

In some embodiments, when multiple Sync signals are transmitted in the same OFDM symbol, whether to use of aggregated Sync signals or a subset of Sync signals (e.g., part of the long sequence) may be determined based on one or more of WTRU-sided conditions, NW-sided conditions, and/or spectrum related conditions.

In some embodiments, a first WTRU may use aggregated Sync signals to detect an SSB and a second WTRU may use a subset of Sync signals (e.g., a part of the long sequence) to detect an SSB, wherein the first WTRU may be a WTRU capable to receive signal in wider bandwidth and the second WTRU may be a WTRU capable to receive signal in limited frequency bandwidth.

In some embodiments, one or more component Sync signals may be used for TN cell and aggregated Sync signals (e.g., equivalent to long sequence) may be used for NTN cell. Based on detected Sync signals, a WTRU may identify the network types (TN or NTN).

In some embodiments, a WTRU may determine its coverage level based on the latest connection quality of the cell. In some embodiments, when the WTRU attempts to reconnect to the network, the WTRU may start with the coverage level of the latest connection quality to detect an SSB. If the WTRU couldn't find an SSB from the determined coverage level, the WTRU may increase coverage level (e.g., aggregation level) of the Sync signal.

PBCH may include component PBCHs (e.g., PBCH part 1 and PBCH part 2 as shown in FIG. 3), and a component PBCH may be repetitively transmitted in time and/or frequency resource within an SSB. One or more of following may apply: one or more component PBCHs may be used and a WTRU may be able to decode the PBCH when more than one component PBCHs are aggregated together. In some embodiments, for example in FIG. 3, a WTRU may be able to decode PBCH when the WTRU aggregates or use both PBCH (part 1) and PBCH (part 2). In this example, a WTRU may be able to receive PBCH without receiving some of OFDM symbol of the SSB (e.g., OFDM symbol #1 or #3).

One or more Sync raster locations (e.g., GSCN numbers) may be determined or configured based on WTRU types. In some embodiments, a middle subcarrier of SS #1 may be the Sync raster location for a first WTRU type (e.g., WTRU type 1) and a middle subcarrier between SS #1 and SS #2 may be the Sync raster location for a second WTRU type (e.g., WTRU type 2), wherein WTRU type may be interchangeably used with WTRU capability, WTRU category, and any other terminologies which may differentiate WTRUs.

With reference to FIG. 5, Sync signals and component PBCHs may have one or more of following configurations as listed in the Table 1 below:

TABLE 1
An example of Sync signal configuration

| | SS#1 | SS#2 | SS#3 | SS#4 |
|---|---|---|---|---|
| Configuration | PSS | SSS | SSS | PSS |
| #1 | | | | |
| Configuration | PSS(part#1) | PSS(part#2) | SSS(part#1) | SSS(part#2) |
| #2 | | | | |
| Configuration | PSS | PSS | SSS | SSS |
| #3 | | | | |

Sync Signal an Sync Signal may be generate from the same sequence (e.g., a long sequence generated and split into SS #1 and SS #2). SS #1 and SS #2 may be generated independently (e.g., different sequence type, sequence index, sequence initialization identity, etc.). SS #2 may be repetition of SS #1. SS #1 and SS #2 are Primary Sync signals (PSS) and SS #3 and SS #4 are Secondary Sync Signals (SSS). In this example, a first WTRU (e.g., with wider bandwidth capability) may have a longer or repeated Sync signal sequences in an OFDM symbol, resulting in better coverage and a second WTRU (e.g., with narrow bandwidth capability) may have a shorter or non-repeated Sync signal sequence in an OFDM symbol, resulting in shorter coverage. SS #1 and SS #4 are PSS and SS #2 and SS #3 are SSS. In this example, a first WTRU (e.g., with wider bandwidth capability) may detect both PSS and SSS in an OFDM symbol and a second WTRU (e.g., with limited bandwidth capability) may detect both PSS and SSS over multiple OFDM symbols (e.g., Symbol #0 and Symbol #2).

In certain representative embodiments, a WTRU may scan subset of SSB components based on the WTRU type, wherein the subset of SSB components may be determined based on the associated GSCN number.

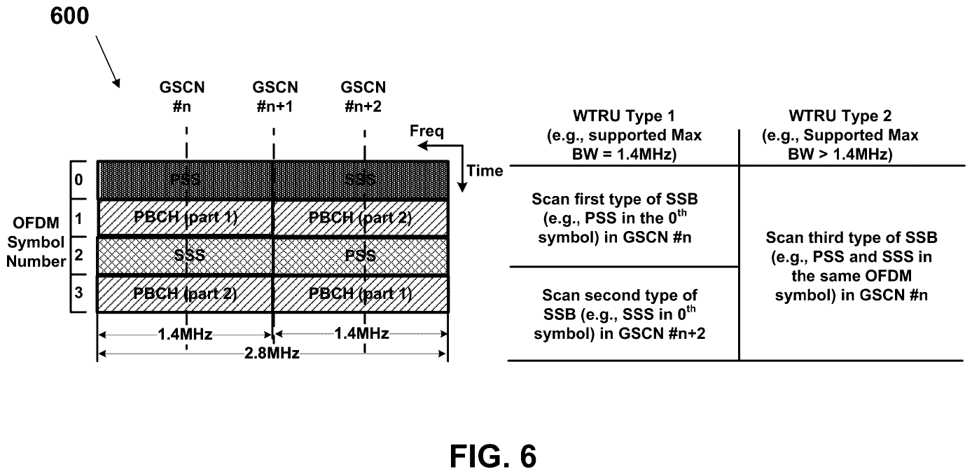

FIG. 6 illustrates association between SSB type 600 and Sync raster number (e.g., GSCN) according to one or more embodiments. An example of the association between SSB type and Sync raster number, and WTRU reception behavior based on the WTRU type is provided.

A WTRU may scan, attempt to decode, or monitor a subset of Sync rasters (e.g., GSCN numbers) based on WTRU capability (e.g., maximum supporting frequency bandwidth). A WTRU supporting a first maximum frequency bandwidth (e.g., 1.4 MHz) scans a first subset of GSCNs (e.g., GSCN #n, GSCN #n+2) while a WTRU supporting a second maximum frequency BW (e.g., >2.8 MHz) scans a second subset of GSCNs (e.g., GSCN #n+1).

An SSB type and/or structure may be transmitted by network and/or scanned by WTRU in a subset of GSCNs.

A first SSB type (e.g., narrow BW) and/or structure may be scanned by all WTRU types and/or capabilities; while a second SSB type (e.g., wider BW) and/or structure may be scanned by a WTRU supporting larger than the frequency bandwidth of the second SSB type.

A first WTRU type (e.g., supporting maximum BW is limited to 1.4 MHz) may scan one or more SSBs over GSCN numbers associated with a first SSB type (e.g., SSB within 1.4 MHz). Herein, the associated GSCN numbers may be GSCN #n and GSCN #n+2. As shown in FIG. 4, the SSB at GSCN #n may be based on first SSB structure (e.g., in the first SSB type) in the order of PSS, PBCH(part 1), SSS, and PBCH(part2) in time domain; the SSB at GSCN #n+2 may be based on SSB structure (e.g., in the first SSB type) in the order of SSS, PBCH(part2), PSS, and PBCH(part1) in time domain.

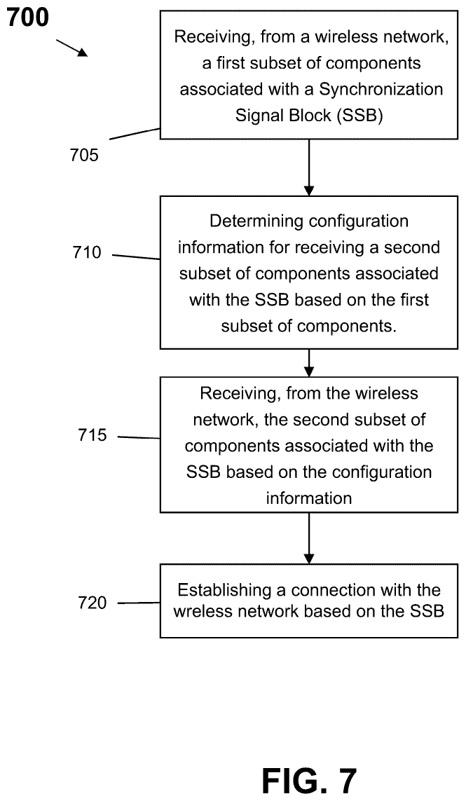

FIG. 7 illustrates a method 700 for establishing a connection with a wireless network using an SSB according to one or more embodiments. The method 700 may be performed by a WTRU such as any of the WTRUs 102 of FIGS. 1A-1D. The method 700 may include receiving 705, from a wireless network, a first subset of components associated with a Synchronization Signal Block (SSB). In some embodiments, the first subset of components may correspond to the common PBCH, PSS and/or SSS of FIG. 3 or FIG. 4.

The method 700 may include determining 710, configuration information for receiving a second subset of components associated with the SSB based on the first subset of components. The method 700 may include receiving 715, from the wireless network, the second subset of components associated with the SSB based on the configuration information. In some embodiments, the second subset of components may correspond to the dedicated or additional PBCH of FIG. 3 or FIG. 4.

The method 700 may include establishing 720, a connection with the network based on the SSB.

In some embodiments, a format type of the SSB may be determined based on at least one of a capability associated with the WTRU, a type associated with the wireless network, or a type associated with the WTRU.

In some embodiments, the first subset of components may indicate a Radio Access Technology (RAT) associated with the wireless network.

In some embodiments, the Radio Access Technology (RAT) associated with the wireless network may be indicated by at least one of a frequency location, a characteristic of synchronization signal received, or a physical cell-ID.

In some embodiments, the first subset of components may comprise a Primary Synchronization Signal (PSS) and a Secondary Synchronization Signal (SSS), and the method 700 may further include determining a format type of the SSB based on the PSS and the SSS.

In some embodiments, the second subset of components may comprise Physical Broadcast Channel (PBCH).

In some embodiments, the first subset of components may further comprise shared Physical Broadcast Channel (PBCH) associated with a first RAT and a second RAT, and the second subset of components may comprise dedicated PBCH associated with the second RAT.

In some embodiments, the method 700 may further include determining a format type of the SSB based on at least one of an occupied frequency bandwidth of the SSB, a frequency range, an occupied number of symbols, or an order of SSB components in time.

In some embodiments, the method 700 may further include selecting a portion of the SSB based on at least one of a condition associated with the WTRU, a condition associated with the wireless network, or a condition associated with the frequency spectrum and the method 700 may further include establishing the connection with the wireless network based on the selected portion of the SSB.

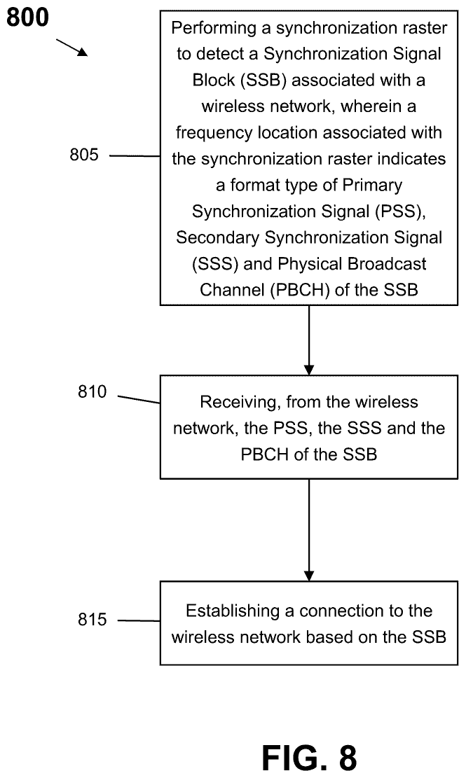

FIG. 8 illustrates a method 800 for establishing a connection with a wireless network using an SSB according to one or more embodiments. The method 800 may be performed by a WTRU such as any of the WTRUs 102 of FIGS. 1A-1D. The method 800 may include performing 805, a synchronization raster to detect a Synchronization Signal Block (SSB) associated with a wireless network, wherein a frequency location associated with the synchronization raster indicates a format type of Primary Synchronization Signal (PSS), Secondary Synchronization Signal (SSS) and Physical Broadcast Channel (PBCH) of the SSB. The method 800 may include receiving 810, from the wireless network, the PSS, the SSS and the PBCH of the SSB. In some embodiments, the PSS, the SSS and the PBCH may correspond to the PSS, the SSS and the PBCH of FIG. 4. The method 800 may include establishing 815, a connection to the wireless network based on the SSB.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), comprising:
receiving, from a wireless network, a first subset of components associated with a Synchronization Signal Block (SSB);
determining configuration information for receiving a second subset of components associated with the SSB based on the first subset of components;
receiving, from the wireless network, the second subset of components associated with the SSB based on the configuration information; and
establishing a connection with the wireless network based on the SSB.

2. The method of claim 1, wherein a format type of the SSB is determined based on at least one of a capability associated with the WTRU, a type associated with the wireless network, or a type associated with the WTRU.

3. The method of claim 1, wherein the first subset of components indicates a Radio Access Technology (RAT) associated with the wireless network.

4. The method of claim 3, wherein the RAT associated with the wireless network is indicated by at least one of a frequency location, a characteristic of synchronization signal received, or a physical cell-ID.

5. The method of claim 1, wherein the first subset of components comprises a Primary Synchronization Signal (PSS) and a Secondary Synchronization Signal (SSS), and the method further comprises:
determining a format type of the SSB based on the PSS and the SSS.

6. The method of claim 5, wherein the second subset of components comprises a Physical Broadcast Channel (PBCH).

7. The method of claim 5, wherein:
the first subset of components further comprises a shared Physical Broadcast Channel (PBCH) associated with a first RAT and a second RAT; and
the second subset of components comprises dedicated PBCH associated with the second RAT.

8. The method of claim 1, further comprising:
determining a format type of the SSB based on at least one of an occupied frequency bandwidth of the SSB, a frequency range, an occupied number of symbols, or an order of SSB components in time.

9. The method of claim 1, further comprising:
selecting a portion of the SSB based on at least one of a condition associated with the WTRU, a condition associated with the wireless network, or a condition associated with a frequency spectrum; and
establishing the connection with the wireless network based on the selected portion of the SSB.

10. A method performed by a wireless transmit/receive unit (WTRU), comprising:
performing a synchronization raster to detect a Synchronization Signal Block (SSB) associated with a wireless network, wherein a frequency location associated with the synchronization raster indicates a format type of Primary Synchronization Signal (PSS), Secondary Synchronization Signal (SSS), and Physical Broadcast Channel (PBCH) of the SSB;
receiving, from the wireless network, the PSS, the SSS, and the PBCH of the SSB; and
establishing a connection to the wireless network based on the SSB.

11. A wireless transmit/receive unit (WTRU) comprising:
a processer; and
a transceiver, wherein the WTRU is configured to:
receive, from a wireless network, a first subset of components associated with a Synchronization Signal Block (SSB);
receive configuration information for receiving a second subset of components associated with the SSB based on the first subset of components;
receive, from the wireless network, the second subset of components associated with the SSB based on the configuration information; and
establish a connection with the wireless network based on the SSB.

12. The WTRU of claim 11, wherein a format type of the SSB is determined based on at least one of a capability associated with the WTRU, a type associated with the wireless network, or a type associated with the WTRU.

13. The WTRU of claim 11, wherein the first subset of components indicates a Radio Access Technology (RAT) associated with the wireless network.

14. The WTRU of claim 13, wherein the RAT associated with the wireless network is indicated by at least one of a frequency location, a characteristic of synchronization signal received, or a physical cell-ID.

15. The WTRU of claim 11, wherein the first subset of components comprises a Primary Synchronization Signal (PSS) and a Secondary Synchronization Signal (SSS), and the WTRU is further configured to:
determine a format type of the SSB based on the PSS and the SSS.

16. The WTRU of claim 15, wherein the second subset of components comprises a Physical Broadcast Channel (PBCH).

17. The WTRU of claim 15, wherein:
the first subset of components further comprises a shared Physical Broadcast Channel (PBCH) associated with a first RAT and a second RAT; and
the second subset of components comprises a dedicated PBCH associated with the second RAT.

18. The WTRU of claim 11, further configured to:
determine a format type of the SSB based on at least one of an occupied frequency bandwidth of the SSB, a frequency range, an occupied number of symbols, or an order of SSB components in time.

19. The WTRU of claim 11, further configured to:
select a portion of the SSB based on at least one of a condition associated with the WTRU, a condition associated with the wireless network, or a condition associated with a frequency spectrum; and
establish the connection with the wireless network based on the selected portion of the SSB.

20. The WTRU of claim 19, wherein the condition associated with the WTRU comprises a supported bandwidth by the WTRU and the selected portion of the SSB corresponds to the supported bandwidth.
